(19) United States
(12) Patent Application Publication
(10) Pub. No.: US 2006/0271436 A1
(43) Pub. Date: Nov. 30, 2006

(54) Organization-powered online benefits management system and method with dynamically-published benefits web site and data and financial tracking

(76) Inventors: Eric Aubertin, Montreal (CA); Martin Rousseau, Montreal (CA)

Correspondence Address: FAY KAPLUN & MARCIN, LLP, 15O BROADWAY, SUITE 702, NEW YORK, NY, 10038, US

(21) Appl. No.: 11/430,765

(22) Filed: May 9, 2006

Related U.S. Application Data
(60) Provisional application No. 60/678,789, filed on May 9, 2005.

(51) Int. Cl. G06Q 30/00

(52) U.S. Cl. 705/14

(57) ABSTRACT

In a method and system for managing a computer network-based loyalty and benefits program for an organization, the following operations are implemented. A network-based access benefits web site for the organization is first dynamically generated. Then, the network-based benefits web site indicates the information concerning partners of the loyalty and benefits program, the partners providing benefits. Also, a promotional object is further supplied to members, the promotional object allowing the members to access the network-based benefits web site and to use the benefits from the partners. In addition, the benefits web site information is dynamically published and controlled, and when the members use the benefits from the partners, the partners honor the benefits they have agreed to provide.

### CLAIM OF PRIORITY

The application claims the benefit of U.S. Provisional Application Ser. No. 60/678,789 filed on May 9, 2005, the specification of which is expressly incorporated herein, in its entirety, by reference

### FIELD OF THE INVENTION

The present invention generally relates to loyalty and benefits management systems. More specifically, but not exclusively, the present invention is concerned with a system and method for managing a computer network-based loyalty and benefits program of an organization.

### BACKGROUND OF THE INVENTION

Typically, loyalty and benefits programs are used to encourage repeated business by rewarding customers for their loyalty towards the same company.

Loyalty and benefits programs have gained in popularity immensely in the past few decades, partly due to the development of a culture of entitlement, in which consumers feel that they deserve special treatment and partly due to the era of computerization. Indeed, computers have made loyalty and benefits programs much more feasible by providing data storage, management and communication means.

However, conventional on-line benefits programs are not flexible. Organizations offer only one or a few benefits to their members. They have to ask the IT (Information Technology) staff to post the benefits on their normal web site in order to display the benefits. No system helps them design and manage their program like adding or removing benefits, tracking of online visitors, viewing online sales, etc. Furthermore, the benefits cannot be updated dynamically.

Typically, conventional online systems for benefits programs involve several parties: the organization seeking to acquire and retain constituents or generate new revenue, partners participating in the benefits programs, and constituents or members. Many organizations offer or sell a card to their constituents so that when these members use their cards at participating partners, they can enjoy the benefits they are entitled to. For this purpose, the IT person at the organization would post a link with some information about the provided benefits. The benefits are typically posted on the regular web site of the organization. Usually, the person in charge of the benefits needs to ask the IT person to post new benefits and remove the old ones. By letting constituents or members know about the provided benefits is a portion of a loyalty program. In order to build loyalty, many other elements need to be present such as frequently interacting with constituents, continually adding new benefits, seeing which benefits are being used, getting feedback, getting constituents to provide additional benefits, etc. Thus there is very little interaction and options between different parties involved in a conventional online system for loyalty and benefits programs. Therefore, more flexibility and ability are sought for systems designing, altering and managing such benefits programs. So far, no system has been dedicated to allow flexibility and modularity in managing, designing, and altering programs for more complex applications needed to foster long term relationships and loyalty. Also, there is no online management tool which integrates easily and smoothly all the parties involved in a loyalty and benefits program for any types of organizations in order to produce statistics, to track and gather data.

As loyalty and benefits programs tend themselves to get more and more complicated, it is therefore a need to have a powerful tool which can help organizations to design and manage their loyalty and benefits programs. Ultimately, the success of loyalty and benefits programs depends on a) how well the organization uses and manages the data it gathers to further refine its policies and loyalty and benefits programs, b) the frequency of interaction with constituents, and c) the organization's ability to provide a continued flow of benefits, benefits that people use ideally on a daily basis. Therefore the design and the management of the loyalty and benefits program as well as the level of two-way interactivity is very crucial to its activities and success.

### SUMMARY OF THE INVENTION

More specifically, in accordance with an aspect of the present invention, there is provided a method for managing a computer network-based loyalty and benefits program for an organization, the method comprising:

generating a network-based access benefits web site for the organization;

listing information concerning at least one partner of the organization on the network-based access benefits web site; the partner information including at least one benefit;

supplying a promotional object to at least one member; the promotional object allowing the member to access the network-based access benefits web site and to use the at least one benefit from the at least one partner;

wherein a) information on the network-based access benefits web site is dynamically published and controlled; and b) usage of the at least one benefit from the at least one partner by the at least one member operates the computer network based loyalty and benefits program to render the at least one member loyal to the at least one partner and/or at least one partner loyal to the organization.

According to another aspect of the present invention, there is provided A method for implementing an on-line loyalty and benefits program for a organization, the method comprising:

supplying a promotional object to at least one member;

providing an on-line web site for the organization, accessible to the member via the promotional object; the web site allowing interactive communication between the member and the web site;

providing, on the web site, at least one benefit supplied by at least one partner of the organization; the benefit being available for the members via the promotional object;

wherein a) the at least one partner and the at least one benefit are dynamically published and controlled; and b) usage of the at least one benefit from the at least one partner by the at least one member operates the on-line loyalty and benefits program to render the at least one member loyal to the at least one partner and/or at least one partner loyal to the organization.

According to another aspect of the present invention, there is provided a system for managing a computer network-based loyalty and benefits program for a organization, comprising:

a server adapted to store a program code;

a network in communication with the server, the program code being structured to program the server to perform a method of managing a computer network-based loyalty and benefits program for a organization, the method comprising:

generating a network-based access benefits web site for the organization; and

listing information concerning at least one partner of the organization on the network-based access benefits web site, the partner information including at least one benefit;

a promotional object supplied to at least one member, the promotional object allowing the at least one member to access the network-based access benefits web site and to use the at least one benefit from the at least one partner;

wherein a) information about the network-based access benefits web site is dynamically published and controlled; and b) usage of the at least one benefit from the at least one partner by the at least one member operates the computer network based loyalty and benefits program to render the at least one member loyal to the at least one partner and/or at least one partner loyal to the organization.

The foregoing and other objects, advantages and features of the present invention will become more apparent upon reading of the following non-restrictive description of illustrative embodiments thereof, given by way of example only with reference to the accompanying drawings.

### BRIEF DESCRIPTION OF THE DRAWINGS

In the appended drawings:

FIG. 1 is a schematic diagram showing the various elements in a method of online benefits management according to an illustrative embodiment of the present invention;

FIG. 2 is a schematic diagram showing a technical infrastructure for a benefits management system supporting the method of FIG. 1; and

FIG. 3 is a flow chart of steps involved in the method of FIG. 1.

### DETAILED DESCRIPTION

Definitions

Brief definitions of some of the terms used to describe an illustrative embodiment of the invention are provided below.

The term “Members” refers to a constituent or a person that is automatically entered or joins a loyalty and benefits program offered by an organization.

An “Organization” is the grouping of any 3 individuals or more and can take the shape of a membership organization, an alumni association, a registered or non registered charity, any type of companies, schools, community groups and sports organizations, or any other types of groups of 3 people or more, which desires to acquire and retain supporters, members, clients, etc., by offering a loyalty and benefits program.

A “Loyalty and benefits program” refers to a program provided by an organization, whereby its members are given special privileges, benefits and access to certain information in order to build stronger relationships between the organization and its members. Such loyalty and benefits program may or may not be used to raise money or generate revenue.

The expression “Central Organization” is the body that implements the system and method according to the illustrative embodiment described herein.

“Promotional Object” is the expression used to describe an item that may have a code, number, or some sort of chip or device that provides the system and the participating merchants with the ability to identify who the member is, which organization the member belongs to in regards to the benefits plan.

“Benefits web site” is the expression used to designate a web site which presents the benefits offered to the members of a loyalty and benefits program, which can be accessed by its members and can display the different benefits plans, provide the ability for members to receive more benefits, presents information about the benefits and the organization, etc.

The “Administration, communication and data center” refers to the centralized part of the system which allows to perform management of the loyalty and benefits program and the benefits web site, information and data storage, and communications

“Benefits plan” refers to a plan which rewards people who participate in a loyalty and benefits program. Benefits can have a local, regional, national or international scope.

The System

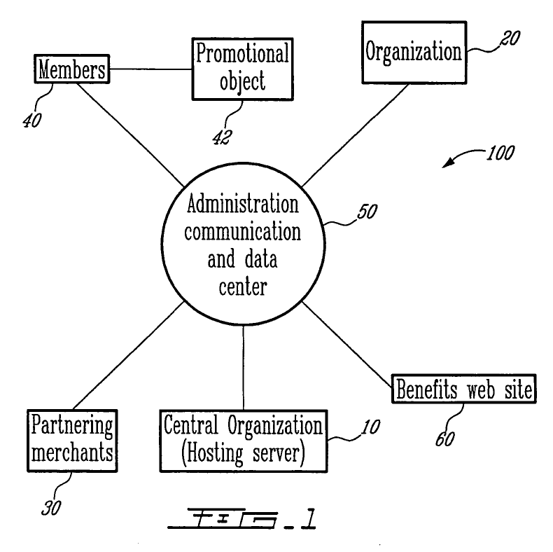

FIG. 1 shows a schematic diagram of the different entities/elements involved in a system 100 for online benefits management according to an illustrative embodiment of the present invention. The hosting server of the central organization 10 offers a platform and interface for an organization 20 to create its own benefits web site 60 and to draw traffic to this benefits web site 60. Administration, communication and data activities of the benefits web site 60 are centralized in an administration, communication and data center 50 and allow interaction and collection of information with the different participants involved in a loyalty and benefits program. The different participants of such organizations are partnering merchants 30 and members 40. Finally, the members 40 validate their access to the benefits web site 60 through a promotional object 42, which will allow them to be recognized by the system 100 and to be associated with a certain benefits plan. It is to be noted that partnering merchants 30 are not always supporting only one organization 20.

The Organization

As mentioned hereinabove, the organization 20 can represent any of the following: a membership organization, an alumni association, a charity, a local community group, a church, a school, a sport organization, a company (for their clients, for their channel partners and/or for their employees), or a union, basically, any “community” of more than 3 people or any group of people. The goal, usually, of the organization 20 is to acquire and retain members by providing privileges and benefits, to raise money or increase revenues and/or build stronger relationships with its clients and partners and to gather information and statistics about its members. For that purpose, the organization 20 will generally need to set a loyalty and benefits program with a benefits plan, as will be described herein below.

The Partnering Merchants

The partnering merchants 30 can be any businesses, stores, restaurants, hotels, groups or associations that agree to provide benefits in various ways, shapes and forms to members 40 who adhere to the organization 20 or the loyalty and benefits program. For example, benefits can take the shape or form of rebates (dollars off), discounts (percentage off), free items and gifts, points or miles accumulated, special information, preferential services, etc. The partnering merchants 30 have to be approved by the central organization 10 and sometimes accepted by the organization 20 but not generally in order to participate in the loyalty and benefits program. The participation may be for a short or long period of time. Also, the partnering merchants 30 may provide a royalty back to the central organization 10, or sometimes to the organization 20, a certain predetermined portion of the money they get from a member 40 every time that the member 40 purchases a product or service from them.

The partnering merchants 30 and the central organization 10 may work together with a third party to make tracking of royalties owed back to the organization 20 possible such as banks, VISA, Master Card, debit card or any other companies that could provide some type of technology connection (for example using satellites) between the system 100 and the partnering merchants 30 and their different points of sales (such as online sales, stores, etc.).

The Members

The members 40 can be clients and individuals who have decided to support the organization 20 or to become members. Examples of members 40 include: donors, alumni, volunteers, employees, clients or constituents of any type. Essentially, the members 40 are constituents who belong to the organization or are interested, have joined, or have supported the organization 20.

The Promotional Object

Generally, the promotional object 42 is the tool or a type of identification that allows members 40 to be part of the loyalty and benefits program. The promotional object 42 most often bring people to register to the loyalty and benefits program with a URL of where the benefits are presented listed on the promotional object. It also allows people to become members 40 of an organization 20. The promotional object 42 has a code or any adequate mechanism to allow the organization 20 to recognize the member 40 having such a promotional object 42 and to enjoy benefits from the participating partnering merchants 30. The partnering merchants 30 recognize the promotional object 42 as presented by the member 40 and can therefore provide the applicable benefit that the partnering merchants 30 have agreed to provide with the central organization 10. The promotional object 42 may take any form, as described herein below.

The promotional object 42 does not necessarily have to be a tangible object and can be intangible.

The promotional object 42 can be a tangible good such as, for example: a savings card that provides savings to the buyer, a coupon on which is printed a number or a web site address, a numbered plastic card, a numbered or coded coupon, a bag of coffee with a code on it, or any other type of object that identifies a member 40 of the organization 20.

The promotional object 42 can be a tangible good, associated to a wirelessly enabled device or service that provides a code and/or a web site link to the provided benefits and detects who the member is and which organization it belongs to, such as, for example: RFID (radio frequency identification device), Text Messaging (SMS) or any scanning device. Those devices recognize the members 40 through a special code given by their promotional objects 42 in order to associate the members 40 to a corresponding code or site which provide them benefits. A phone could also serve as the promotional object 42 with a special chip recognized by the partnering merchants 30. Additionally, the promotional object 42 such as a phone could be connected to a satellite network that would identify the current location of a member 40, for example New York city in zip area 10016, and would then present to the member 40 the partnering merchants 30 located in that specific area.

The promotional object 42 can be a non-tangible good such as, for example: a code in a television program, a special access pass to a “Benefits Club”, an online coded promotion (with a cookie or special URL tracking) and a wirelessly transmitted code.

The promotional object 42 can be anything that invites potential members online and/or to any type of data capturing device or technology, in order for the potential members to register to the benefits web site 60 and provide information about themselves for becoming members 40 and participating in a fundraising campaign for example, joining the membership organization or an alumni. Therefore, the main goals of the promotional object 42 is to a) bring potential members to register, b) drive members 40 back to the benefits web site 60 to receive benefits, c) serve as the element that provides a confirmation to the partnering merchant that the member deserve a benefit, and finally d) identifies the member in the central database.

The promotional object 42 can be given for free or purchased online, offline or through any other method. The promotional object 42 can be promoted by the organization 20 either online, wirelessly, through the media, through mailings, e-mails, through its existing members 40, for example.

The promotional object 42 can, as will often be the case, provide benefit(s) to the members 40 such as giving them discount savings, entitle them to free products/services, entitle them to receive free information about the organization 20 or other types of information.

The promotional object 42 can offer anything that is perceived as a value-added benefit for having purchased a product or simply having taken the time to register personal information online at a specific benefits web site 60 as identified on the promotional object 42.

The Benefits Web Site

Each organization 20 gets one benefits web site 60 provided by the central organization 10. The benefits web site 60 is customized through the use of a dynamically publishing system that can be managed by the organization 20 and/or by the central organization 10.

The benefits offered to members 40 pull them to visit the benefits web site 60 and therefore the benefits bring traffic to their main web site since typically, members 40 access the benefits web site 60 through the organization's main web site or a link from the benefits web site 60. Since people visit the benefits web site 60, it creates the opportunity to present new content, new information, news, and it also creates an online area where members 40 can feel good to go since they are rewarded and informed. Furthermore, one of the functions of the benefits web site 60 is to gather information from members 40 as they visit the benefits web site 60 for personalizing their preferences and for statistical purposes.

All the content presented on the benefits web site 60 can be customized and the look can be changed through the use of the administration, communication and data center 50, All these changes can be administrated by either the central organization 10 or the organization 20.

Features that can be customized on the benefits web site 60 include, for example: changing the colors used, the corner image or other images on the web site, the logo, the content and the links provided at the top of the page. The top page links may include, for example: join now, program info, refer a merchant, link to home page, events, customer service, tell-a-friend, my profile, and privacy. All these changes can be administrated by either the central organization 10 or the organization 20.

In general, the personalized benefits web site 60 of a particular organization 20 has a similar look and feel as the main web site of this organization 20. More specifically, the benefits web site 60 presents new content all the time, features the organization's logo, remains top of mind, and continually interacts with members 40 to inform them and keep them updated of the benefits they are entitled to. It is interesting to constantly update and enhance the benefits web site 60 since, as stated earlier, the features and content of the benefits web site 60 are used to pull the members 40 to visit the benefits web site 60, and to generate traffic to the main web site of the organization 20. And since the frequency of interaction between the organization 20 and its members 40 is a critical element in building long term relationship and loyalty, the system 100 helps organizations 20 dynamically and often change and alter the program to further give new reasons for members 40 to visit the benefits web site 60.

The benefits web site 60 can be viewed as the Front End technology or what the public and the members 40 see.

Furthermore, the benefits web site 60 may take the form of a handheld device, a phone, a system connected to a satellite or any wirelessly capable device, basically any device that may show the benefits and can provide access to the members 40 through the system 100.

The benefits web site 60 may optionally be personalized, for example to greet a visiting member 40 with the member's name or personal information as the member 40 visits the benefits web site 60, in addition of personalizing the look, preferences and content, if applicable.

Also, members 40 may optionally select their own preferences with regards to benefits they wish to have access to, changing category of benefits, such as upgrading their benefits from one type of programs to another typically for a fee, changing the colors, being notified of certain types of deals or offers via e-mail or print materials, basically any type of personalization based on the preference of each member 40. For example, the options may include: name, colors, content, benefits, frequency of communication desired, type of offers, reminders for various types of information, events, etc. Other examples may further include renewal notification preferences and royalty & rebate options, etc.

The benefits web site 60 may also be accessed by potential partnering merchants. Indeed, the web site 60 may include the ability for potential partnering merchants to submit an application in order to become a partnering merchant 30. Such application may then be processed by either the central organization 10 or the organization 20. It also provides the opportunity for members 40, for those of them who may own businesses, to apply to also become a partnering merchant 30.

Finally, the benefits web site 60 can be co-branded with two different organizations 20 or with any other amount of organizations 20.

The Administration, Communication and Data Center

Management of the benefits web sites 60, by either the organization 20 or the central organization 10, is possible through the administration, communication and data center 50. Indeed, the administration, communication and data center 50 comprises several modules that can be turned on or off according to the preferences of the organization 20, and accomplish different tasks:
content module;
registration module;
benefits management module;
statistics module;
communication module;
database module;
searching module;
profiling module;
sales module; and
enrollment management module.

The above mentioned modules generally allow for performing eight main tasks:
1. Managing the provided benefits, those provided by the central organization 10 and/or those added by the organization 20 itself;
2. Gathering data and keeping accurate data on members, and managing categories and information from members;
3. Gathering statistics on usage, getting feedback, reporting functions, and managing categories and information from members;
4. Managing money owed back to the organization 20;
5. Communicating at a click of a button with all members 40 or categories of members;
6. Managing the promotional object 42 management and assignment;
7. Automating tasks such as sending automatic reminders when the promotional object such as a benefits card is about to expire;
8. Directly communicating and servicing with the central organization 10 and the organization program preferences selection

When the organization 20 decides to change the look, feel and content of its benefits web site 60, the central organization 10 offers a user friendly environment for the organization 20 to do so, through the different modules of the administration, communication and data center 50. Indeed, the central organization 10 provides instructions and tips on how to use the system so that the organization 20 can change the content as often as desired (through the content module), upgrade the look from time to time, gather information about members 40 when they register and validate the data (through the registration module), conduct surveys (through the statistics module), send personalized e-mails messages to all or to a selected few members 40 (through the communications module), create automatic reminders, add and remove provided benefits, add new services (through the benefits management module), approve or reject new merchants, search of benefits and partnering merchants 30 (through the searching module). Basically, the administration, communication and data center 50 allows for managing the entire benefits plan by adding new features, presenting new benefits programs, and helping manage memberships and communications.

Moreover, the administration, communication and data center 50 permits to gather statistics and generate reports, create, manage, and view surveys, and provide analyses. Also, the administration, communication and data center 50 allows to easily upload/import data into other software such as spreadsheets and to print reports. Finally, the administration, communication and data center 50 permits to view sales, rebates and royalties owed to the organization 20. This data center 50 can be viewed as the back-end of the system, which is hidden from the public and members 40.

Furthermore, the administration, communication and data center 50 is the place where all the information, accessed by the organization 20 flowing in from the members 40 or the central organization 10 and flowing out to members 40 or the central organization 10, is stored. This information resides in the private section of the system 100 provided by the administration, communication and data center 50 and can be accessed with a username and password, which are provided by the central organization 10 and the system 100.

The information consists of a database, used by the organization 20 to tie together all the information about the organization 20, about the promotional object 42 and about the members 40 as well as their actions and preferences. All that information is accessible online for the organization 20 and/or the central organization 10 to use.

Obviously, this information is invisible to the public and the members 40. Only the authorized personnel of the organization 20 has access to the system using a given username and password.

The organization 20 has the ability to segregate its database in various categories of members 40 for the purpose of gathering statistics by categories and/or to communicate with a particular category of members 40.

Moreover, partnering merchants 30 may also have the possibility to access the administration, communication and data center 50, using a username and password in order to manage their own statistics, data and view their results. They can choose to remain active or deactivate their participation to the loyalty and benefits program based on their agreement with the central organization 10. The partnering merchants 30 only see the information that relates to them and only the information that the central organization 10 makes available for them to see.

In the same way, as in the case for the organization 20, the partnering merchants 30 can manage the information related to themselves, such as changing their logos, creating surveys and printing reports, displaying their benefits offers, referring other merchants, and communicating with the members 40 of the organization 20.

Optionally, a call center module can be present so that when the organization 20 wishes to sell its promotional objects 42 through a call center, the organization 20 has the ability to do so. Information that should be shared with the people making the calls is then made available through a special Data & Communication Center made available through a username and password for the Call Center and then some screens would present the right information to people making the calls to the potential members or supporters.

Finally, the administration, communication and data center 50 allows for multi-level sales tracking and multi-level access for organizations 20 which have many levels, such as national, regional, and local. For example, the administration, communication and data center 50 can be the back-end for the central organization 10, the organization 20 or even a third party such as a national association that manages all the benefits web site 60 for all their chapters. The national association would be given a special username and password to access all the information concerning its chapters.

The Infrastructure of the System

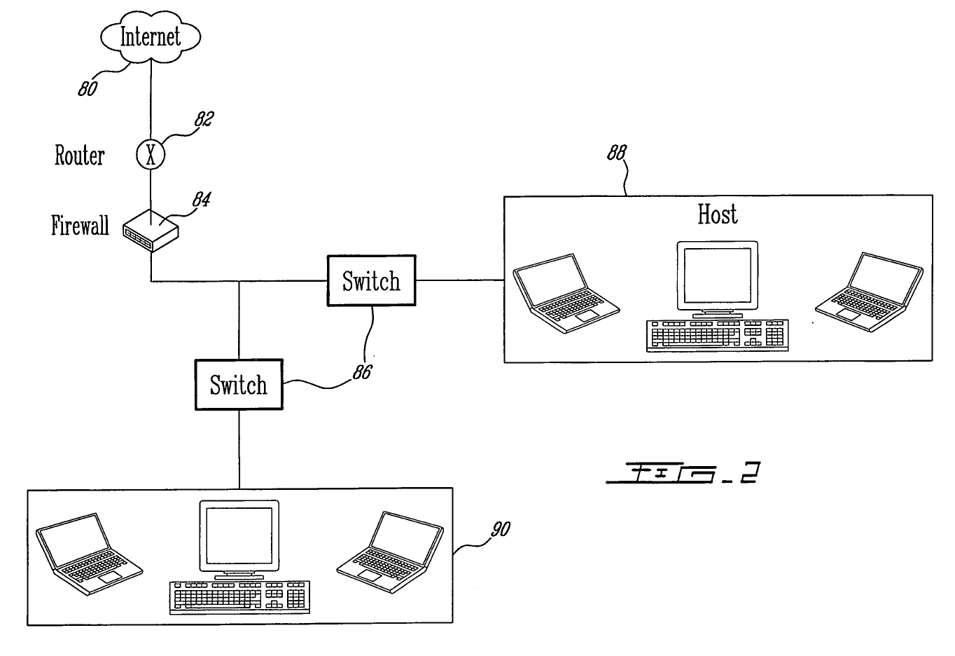

Referring now to FIG. 2, an illustrative schematic representation of a possible interconnected web-based system that can be configured to operate in accordance with the illustrative embodiment the present invention is shown. Members 40 or partnering merchants 30 may access via Internet 80 the web-based system and hosting platform 88 provided by the central organization 10, which is articulated around Open Source Software. Both the hosting platform 88 and an internal network 90 are connected to Internet 80 via some switches 86, a firewall 84 and a router 82. The firewall 84 has been developed by the central organization 10 from their own kernel in order to protect the internal network 90 and the hosting platform 88 from potential attacks coming from Internet 80. Activities between Internet 80 and the internal network 90 and the hosting platform 88 are efficiently and closely monitored. All communications are occurring under secured protocol via SSH.

The hosting platform 88 provides the administration, communication and data center 50. It comprises a server which uses, for example, RedHat as its operating system. Furthermore, this server may comprise a web apache server, a sendmail mail server, and MySQL databases. Programming may be performed using Perl, PHP, and Java on the server, emphasizing on a modular and independent structure of the program in order to allow a maximum of flexibility. The system and technology may evolve over time and for example, .Net technology rather than Java and various technology elements may change but the functionality and guiding principles and flow of the system will remain the same. The description of the current system is present to provide an example of how the system could operate from a technology standpoint.

The internal network 90 also comprises a server 92 using, for example, Windows and some workstations connected thereto.

Process of Using the System

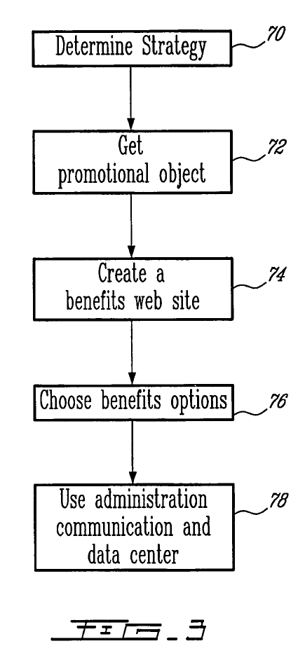

Referring to FIG. 3, the flow chart shows the procedure consisting of different steps for an organization 20 to use the web-based infrastructure provided by the central organization 10. First, a strategy on how to reach people and promote activities has to be determined by the organization 20, at step 70. Members of the central organization 10 may help in this regard. Then, the organization 20 has to create or get a promotional object 42 at step 72, again, with the potential help from the central organization 10. Very often the central organization will create the promotional object for the organization. Then the central organization creates a profile for that organization and the system creates a username and password for that organization. After which, the organization 20 or the central organization can create a benefits web site 60 in order to develop loyalty, to raise money or increase revenues for example. Through that process, the benefits plan that will be offered and presented on the benefits web site is decided and the system is set to present the right level of benefits for the right members or constituents. Finally, using the administration, communication and data center 50 through a username and password given to the organization by the central organization, the organization 20 can control and improve its benefits web site 60 and loyalty program and use all the technology features to add and remove benefits, send e-mails, view statistics, etc.

More specifically, at step 70, the organization 20 determines a strategy such as including the promotional object 42 and provided benefits within its fees or promoting the ability for their members 40 to access more benefits for a fee or a charity using the card to raise money.

In step 72, the chosen promotional object 42 is created or purchased and can then be distributed to people. For example, the organization 20 can use or make its own promotional object 42 or the central organization 10 can provide the promotional object 42 to the organization 20.

Once the promotional objects 42 are available, the organization 20 proceeds to the next step 74 of creating its own benefits web site 60 in order to implement its strategy using the promotional object 42. More specifically, the organization 20 registers as a new client of the central organization 10 on the administration, communication and data center 50 and creates its own benefits web site 60. The central organization 10 can do that for the organization 20 as well.

In step 76, the organization 20 can choose its own preferences in terms of benefits options and customize its benefits plans and rewards programs. Depending on the chosen strategy and their budget, the organization 20 would seek more or less benefits from the central organization 10 that could typically provide all the partnering merchants 30 in its database. Or sometimes the organization 20 would itself approach directly potential partnering merchants to provide benefits. Together, they can develop and establish benefits plans based on their agreements and typically the central organization 10 would charge the organization 20 a yearly or monthly fee per member 40 per period, for example one year, based on the degree of benefits provided to the members 40.

Finally, in step 78, using the administration, communication and data center 50, the organization 20 has the power to manage its benefits web site 60 dynamically and at will, to control its activities and stay in touch with its members 40 and partnering merchants 30. More specially, reports and analyses on statistics and financial tracking can be produced and viewed. Furthermore, the organization 20 can add its own partnering merchants 30 to the system 100 only for its benefits web site 60 or in the central organization's database of partnering merchants 30.

The goal of implementing such an online loyal and benefits program is to establish loyalty to the organization 20 from both the members 20 and sometimes from the partnering merchants 30. Indeed, when a member 40 uses the promotional object 42 at the partnering merchants 30, the member 40 gets benefits such as discounts and the partnering merchants 30 are provided with clients. Therefore, both the member 40 and the partnering merchants 30 are provided with advantages and enjoy the loyalty and benefits program.

An Example of Application

As an example of a possible application of the present invention, we will assume that a benefits card would be used as a promotional object 42. A typical process as defined in FIG. 3 will be described herein below.

A fundraising organization 20, such as a charity organization, that needs to raise money, decides on a strategy to implement its fundraising activities and campaign, using a benefits card and a benefits web site 60.

First, the fundraising organization 20 creates the benefits card typically designed and printed by the central organization 10. Usually, the name or the logo of the fundraising organization 20 may be printed on the front of the benefits card. The front of the cards typically are printed in 4 colors through an external printer. The back of the benefits cards is white and is used by the central organization 10 to print, for example, the benefits card's number, sometimes the name of the member 40, the URL where the benefits can be accessed, the expiration date, the name of the organization 20, the legal usage of the card, as well as a dominant text that prompts people to register their card online. Additionally, often a sticker would be placed on the top of the card saying “Must Register your Card Online Before Enjoying Benefits” to ideally ensure that people register their cards and thus see all the benefits they can enjoy. The benefits card, if provided by the central organization 10 is typically renewed every year for example with a new look and typically a new expiration date. The fundraising organization 20 can decide to sell the benefits card for a certain amount of money, for example $40, thus making some upfront money. Usually, the card gives privileges and benefits, provided by merchants participating in the fundraising campaign, to the owner (member) of the card each time that he/she uses it.

The partnering merchants 30 are typically provided by the central organization 10. In some cases, the merchants 30 may be solicited by the central organization 10 or the organization 20 for a particular loyalty program and for a particular period of time. Some merchants 30 agree to give a percentage on enjoyed sales, from the purchase made by the members 40, such revenue sharing from the part of the partnering merchants 30 may or may not be shared with the organization 20 by the central organization 10. If royalties on sales is given to the central organization 10 by the participating merchants 30 that agree to provide a revenue share, a system may or may not be present allowing the organization 20 to see the sales results in the administration, communication and data center 50, accessed through its own username and password. However, sometimes, all the benefits can be provided by the organization 20 and only the technology is used by the central organization 10.

Then, the fundraising organization 20 can create its benefits web site 60 and chooses an appropriate benefits plan from the central organization 10. Also, a login banner can be created, which is posted on the main web site of the fundraising organization 20 in order to link the benefits web site 60 thereto. Concerning the benefits card, typically, the fundraising organization 20 may pay a fee for the printing of its member cards or benefits cards as well as a fee per2 online activated card based on the types of benefits plan chosen. The plan may be paid monthly or yearly, can vary from a fee per member per period to a flat fee, or any other financial arrangements.

Each benefits card comprises a card number and an expiration date. For example, a maximum period of 14 months is granted, after which, if not renewed, the card becomes invalid. The URL (or the link to the benefits web site 60) is also written on the card in order to invite people to go online to either activate their benefits card and to become a member 40 or to validate and use their cards if they are already members 40. Optionally, a customer service phone number can be provided by the benefits card. The benefits card numbers or codes represent represents a piece of data for allowing members' profiles to be stored in databases and to be reached by the fundraising organization 20, the central organization 10 or the partnering merchants 30.

Once the benefits cards have been created, they have to be distributed to potential and future members. They can be sold or given freely.

In the process of creating the benefits web site 60, the fundraising organization 20 makes decisions in terms of how they want the benefits program to progress and how they want to use the system 100. For example, communication preferences and frequencies are determined as well as who is the manager of the benefits web site 60 (the fundraising organization 20 or the central organization 10) and mailing options must also be set, etc. The fundraising organization 20 has different sections to realize in order to create and enhance its benefits web site 60, the sections comprising: a creation of a campaign section, a web site content management section, a benefits program selection section, an email management section, a survey and statistics section, a call center section, etc.

To create its benefits web site 60, first, the fundraising organization 20 registers as a client of the system 100 provided by the central organization 10. Then, the fundraising organization 20 customizes its benefits web site 60 as determined earlier by choosing from one of the several categories of benefits plans. The fundraising organization 20 can add or remove any category of benefits plans when desired. This is often done for the organization 20 by the central organization 10.

The fundraising organization 20 can also choose many features provided by different modules mentioned above, which can be activated or not. Some examples include: program information, news, finding a date, matching services, adding images, changing the colors, recruiting and job services, referring a friend, customer services, referring a merchant, chat, donations, events, my profile, links to the main web site, etc.

Furthermore, the fundraising organization 20 can select the types of communications it wishes to have with the central organization 10. It can also allow its members 40 to change the colors of the benefits web site 60 and personalize it. E-mails or e-newsletters can be sent by the organization 20. They can be created and sent by the system 100 after the administrator at the organization 20 has approved the e-mail or it can be sent by the central organization 10 to the members 40.

Once the benefits web site 60 is created, members 40 can have access to the list of benefits provided by the partnering merchants 30, set by the fundraising organization 20. The created benefits web site 60 is automatically linked to the main web site of the fundraising organization 20 and therefore becomes an extension. The benefits card allows for identifying the proper benefits associated to members 40. The member benefits can be accessed directly at a location hosted by the central organization 10 such as http://www.mymembercard.com/abcorg,

More specifically, the procedure for using the benefits web site 60 to raise funds is as follows. The interested people first acquire a benefits card in order to support the fundraising organization 20. They can buy the benefit card from a person or a friend, through the fundraising organization 20 or online. Then, they go online at the URL specified on their benefits card.

Additionally regarding the login banner, embedded within and displayed on the main web site of the fundraising organization 20, it could be just a link or it can welcome the benefits card's identification number in order to link directly to the local benefits, or the organization 20 may decide to simply have a link on its main web site to the appropriate and customized organization's benefits web site.

In the case the login banner needs to be filled out with a valid benefits card number, a login box is displayed. The benefits card's owner (or member 40) enters the card's number in that box. If the benefits card number is correct, the card's owner (member) is led to the benefits web site 60. If the person is not a member and/or has no benefits cards, a “Find Out More” button can be displayed on the main web site and if that person clicks on it, a request form appears, allowing him/her to get additional information.

When a card's owner accesses the web site 60 for the first time, the benefits web site 60 prompts a registration form inviting the card's owner to register in order to activate his/her benefits card. In the other cases, the system 100 periodically invites and prompts members to update their personal information in their profiles and to validate their cards. This feature is generally there but may not be present.

In the registration form, the (future) members 40 are asked to enter information about their name, email address, mailing address, phone number, and some few other questions related to the fundraising organization 20 and some other optional questions, if applicable. All this information is stored in the administration, communication and data center 50 and is accessible by the fundraising organization 20 with a username and password as mentioned earlier. The system also records members' behavior upon each one of their visit to the benefits web site 60 for statistical purposes.

Request forms are used by the benefits web site 60 to manage easily requests received from people who may be interested in the fundraising program. The information collected is again presented live in the administration, communication and data center.

The benefits web site 60 lists all the partnering merchants 30 along with the benefits they offer. Therefore, members 40 can browse through the list and visit merchants which are linked to the benefits web site 60 and can even buy online their products. Or the members 40 can go to the physical stores to buy the desired items. By so doing and providing their benefits card's number, upon the payment transaction, the fundraising organization 20 may receive its agreed royalties from the partnering merchants 30. A search function allows members to look for deals or benefits in their local area or nationally.

Partnering merchants 30 may have special technologies such as scanning systems, whereby people are identified as members of the benefits plan and are given associated benefits. They also may have the ability to load up a debit/credit card whereby the members 40 of the fundraising organization 20 can add money to their debit/credit card with a portion going back to the fundraising organization 20, or simply having a swipe technology that tracks that the member used one or more benefits at the partnering merchants' place of business on a particular date, such info that may or may not be connected to the central organization's database and then optionally made available to the organization.

Finally, the administration, communication and data center 50 allows the fundraising organization 20 to gather data through the benefits card registration process and members profile updating system. The data center 50 is capable of tracking the number of online visitors, to import/export data, to renew the benefits cards and to communicate with the fundraising organization 20 via emails, as well as online sales, if applicable.

The members 40 are notified prior to the expiration of their benefits card if they wish to renew their membership. If they wish so, they can do it through various ways, such as with a credit card, by mail, etc.

New partnering merchants 30 are added periodically. They can be referred by members 40, by the fundraising organization 20, by other partnering merchants 30, etc. Participating partners 30 can be reached by the fundraising organization 20 or the central organization 10. They can also advertise their own web site on the benefits web site 60, along with 1-800 numbers, have the ability to have printed coupons or only X number of printed coupons per period, etc.

The system allows for much flexibility and changes. As mentioned earlier, either the organization 20 or the central organization 50 can create and send e-newsletters on the fly to their members 40, to inform them of new partnering merchants 30, to remind them to use their benefits card, to share new information about the organization 20, etc. For example, dozens of templates for creating e-newsletters are provided by the central organization 10. Also, in some other cases, the members 40 and/or a partnering merchant 30 can be granted the right and the power to control their provide benefits thought their own administration, communication and data center 50.

Indeed, the partnering merchants 30 can have their share of the administration, communication and data center 50, which allows them, for example, to change their logo on the benefits web site 60, to change their discount offers, to display description and/or restrictions of their benefits, to view data and statistics about the offers provided, to manage their participation to the loyalty and benefits program, and to link the benefits web site to their own web sites. All those tasks are performed on a dynamically published basis.

Furthermore, the benefits currently offered by the organization prior to joining the central organization's system can be displayed. Therefore, one can see how the benefits are being used. Also, the system 100 can process data and calculate statistics on registered users, visitors, internal benefits hit and produce statistics with breakdown by categories of benefits. Finally, the system 100 offers the possibility to incorporate the existing benefits of the organization 20.

The system 100 is very flexible and many options are available and can be turned on or off. For example, the option to members to upgrade and receive more benefits for a certain fee or for free can be switched on or off, as well as the option for multilinguism whereby, for example, a Spanish member could click on the Spanish link and the entire benefits web site 60 would be displayed in Spanish, or at least a portion of the benefits web site 60.

The system is very secure as usernames and passwords are required to manage the benefits web site 60.

More specifically, there exists four types of validation to the benefits web site 60: benefits cards provided by the central organization 10 are validated by the system, or benefits cards made by the organization 20 are validated by the system 100 (the system must be able to upload all the benefits cards' numbers into the system), or the organization 20 uses its own cards without validation from the system 100 but the system captures the data, or a simple link is provided to the benefits web site 60 (there is no card and no validation).

Moreover, the system 100 allows to receive comments and feedback about the loyalty and benefits program. This information may be used in order to improve the loyalty and benefits program.

Finally, it should be noted that the benefits card can also take the form of a handheld device that could be scanned or shown and would indicate all privileges of the owner of that device. Moreover, it can be any other items that would have a number or a tracking device to recognize that the owner is a member of the benefits plan. Those devices may or may not use some sort of location-based service such as satellite network, GPS, or any other type of similar services. Other forms for the benefits cards include a smart card, RFID, a chip inserted in a human, etc.

Other possible applications of the system may include: an insurance company using the benefits card and providing benefits to attract new customers and to build long-term relationship with its clients. As they buy their insurance policy from the company, they receive a benefits card that provides them access to benefits for one full year. Clients go online to register their card and see all the provided benefits. The insurance company will personalize its web site by adding other offers, presenting tips, adding more rewards, always communicating and interacting with the clients in order to build loyalty.

Another example may concern a company wishing to provide additional benefits to its employees that become members of a program created with the illustrative embodiment of the system 100, in order to create more interaction between the company and the employees and build stronger relationships. Here interestingly enough is the ability for the company to post the regular employee benefits plan on the Benefits Web Site as an internal benefits, i.e., details about the dental or medical plan, etc.

And another example is given by alumni associations, which require yearly fees to be paid by their members in order to remain active in the associations. Many benefits are provided to the members for them to enjoy and stay connected to their schools and classmates. Alumni can be given the benefits card as a gift after graduating and could be charged after one year only. Also, because alumni associations solicit donations from graduates and alumni on a periodical basis, many alumni associations will opt to keep the card active and pay the fee owed to the central organization 10 to ensure a continued level of interaction, communication, and giving back to alumni in order to receive greater levels of donation when the donation time comes.

Similarly, membership organizations always strive to acquire more members and keep existing members. By providing more benefits through the loyalty and benefits program offered by the central organization 10, the membership organizations can enjoy more revenues. Typically, the membership organizations can integrate the extra benefits fee paid to the central organization 10 within their existing fees, or increase their fees, or if not at the very least provide members with the opportunity to receive more benefits for an extra fee, that typically being done at registration timing or at a separate timing. Most typically, the membership organization would pay a monthly fee to the central organization to give all its members access to the benefits provided by the central organization as well as giving its members the ability to upgrade to more benefits for a fee such as gaining access to benefits like road side assistance, pre-paid legal services, etc.

A great number of advantages can be seen through the use of the system 100 of the present invention to manage an online benefits web site. Indeed, some of the potential advantages of the system 100 allows:
to provide benefits, additional benefits, or provide more or less benefits to members 40 in a click;
to increase revenues and/or raise money for the organization 20;
to gather information/insight about the members 40;
to pull members 40 to the benefits web site 60 and the main web site by offering valuable benefits that constantly evolve and always have something new happening on the benefits web site 60;
to provide a great level of benefits, more importantly benefits that people will use on a daily basis in order to create the habit of using their benefits card and thus creating a barrier to exit the organization 20 such that the organization 20 can enjoy a repeat base of members;
to continually interact/speak and communicate with the members 40 and give them new “things” to be excited about;
to have access to an one-stop-benefits-shop whereby the organization 20, through the central organization that has a wide range of provided benefits through existing benefits packages or “a la carte”, can provide more or less benefits based on its budget and later decide to add more benefits in a click or simply give the opportunity for members 40 to upgrade to more benefits for a fee;
to develop long-term loyalty for the organization 20;
to develop one-to-one and personalized messages for each member 40 as well as to allow the sending of messages to the entire database of members 40;
to reduce communication costs by using the e-Newsletter and e-Mailing system, especially with the central organization creating all the eNewsletters and the organization simply having to approve before the message being sent to the members of the organization;
to help getting people to renew online rather than having to send 4 to 5 mailing pieces before they renew their contribution, support or membership;
to easily create surveys and/or gather feedback from members 40;

to track money owed to the organization 20 by the central organization 10 and/or partnering merchants 30;
to have a system in place that can provide data to partnering merchants 30, agreeing to provide royalties, which can increase revenues for the participating organizations 30, and giving them the tools so helpful to evaluating the efficiency of their provided benefits;
to reduce the workload by simplifying and integrating all the different features within the same system 100, such system that will evolve over time to including new technologies such as phones presenting offers to the members;
to provide the opportunity to members 40 and potential partnering merchants to submit an application to become a partnering merchant 30;
to have a system to manage online requests, people joining or renewing, cards that are about to expire, etc.;
to present the benefits in an organized fashion and make them easy for members 40 to see the value of having such a system 100 that can search for discount offers according to zip area or other criteria as desired by the members 40;
to have a customer service system and platform and 1-800 where members can easily call or send an e-mail to notify that a problem exist with the system, the partnering merchants not honoring the benefits, or any other issues; and
to keep accurate data of the members 40 by allowing them to periodically update their profile through the system 100.

Although the present invention has been described in the foregoing specification by means of a non-restrictive illustrative embodiment, this embodiment can be modified at will within the scope of the appended claims without departing from the spirit and nature of the subject invention.

What is claimed is:

1. A method for managing a computer network-based loyalty and benefits program for an organization, the method comprising:
generating a network-based access benefits web site for the organization;
listing information concerning at least one partner of the organization on the network-based access benefits web site; the partner information including at least one benefit;
supplying a promotional object to at least one member; the promotional object allowing the member to access the network-based access benefits web site and to use the at least one benefit from the at least one partner;
wherein a) information on the network-based access benefits web site is dynamically published and controlled; and b) usage of the at least one benefit from the at least one partner by the at least one member operates the computer network based loyalty and benefits program to render the at least one member loyal to the at least one partner and/or at least one partner loyal to the organization.

2. A method for managing a computer network-based loyalty and benefits program as defined in claim 1, comprising using a dynamically publishing system to dynamically control the loyalty and benefits program and the benefits web site.

3. A method for managing a computer network-based loyalty and benefits program as defined in claim 2, comprising providing the dynamically publishing system with an administration, communication and data center.

4. A method for managing a computer network-based loyalty and benefits program as defined in claim 3, wherein the network-based access benefits web site is managed by the organization through the administration, communication and data center.

5. A method for managing a computer network-based loyalty and benefits program as defined in claim 4, wherein the network-based access benefits web site is further managed by a central organization through the administration, communication and data center.

6. A method for managing a computer network-based loyalty and benefits program as defined in claim 3, wherein the network-based access benefits web site is changed and customized by the at least one member through the administration, communication and data center.

7. A method for managing a computer network-based loyalty and benefits program as defined in claim 3, wherein the network-based access benefits web site is changed and customized by the at least one partner through the administration, communication and data center.

8. A method for managing a computer network-based loyalty and benefits program as defined in claim 4, wherein the management of the network-based access benefits web site comprises changing at least one of looks, feel and content of the network-based access benefits web site.

9. A method for managing a computer network-based loyalty and benefits program as defined in claim 3, wherein e-mails and e-newsletters are sent to the at least one member by the organization through the administration, communication and data center.

10. A method for managing a computer network-based loyalty and benefits program as defined in claim 3, further comprising generating statistics and producing reports through the administration, communication and data center.

11. A method for managing a computer network-based loyalty and benefits program as defined in claim 3, comprising gathering data about members through either the benefits web site and the administration, communication and data center.

12. A method for managing a computer network-based loyalty and benefits program as defined in claim 3, comprising tracking online visitors by means of the benefits web site and the administration, communication and data center.

13. A method for managing a computer network-based loyalty and benefits program as defined in claim 1, comprising providing the network-based access benefits web site through a hosting server.

14. A method for managing a computer network-based loyalty and benefits program as defined in claim 13, comprising managing the network-based access benefits web site through a group of people including an administrator of the organization and an administrator of the hosting server.

15. A method for managing a computer network-based loyalty and benefits program as defined in claim 13, further comprising providing a password-protected user interface that is accessible only by an authorized person.

16. A method for managing a computer network-based loyalty and benefits program as defined in claim 15, wherein the authorized person is selected from a group consisting of a member, an administrator from the organization, a partner of the organization and an administrator from the hosting server.

17. A method for managing a computer network-based loyalty and benefits program as defined in claim 1, comprising providing the promotional object with an identification code.

18. A method for managing a computer network-based loyalty and benefits program as defined in claim 17, comprising providing the promotional object with a logo of the organization.

19. A method for managing a computer network-based loyalty and benefits program as defined in claim 17, comprising providing the promotional object with the URL of the network-based access benefits web site.

20. A method for managing a computer network-based loyalty and benefits program as defined in claim 17, comprising providing the promotional object with an expiration date.

21. A method for managing a computer network-based loyalty and benefits program as defined in claim 17, comprising activating the promotional object online via the identification code in order to register to the network-based access benefits web site.

22. A method for managing a computer network-based loyalty and benefits program as defined in claim 1, comprising listing on the network-based access benefits web site all the partners and the benefits of the listed partners.

23. A method for managing a computer network-based loyalty and benefits program as defined in claim 1, comprising providing the network-based access benefits web site with options for multilinguism.

24. A method for implementing an on-line loyalty and benefits program for a organization, the method comprising:
supplying a promotional object to at least one member;
providing an on-line web site for the organization, accessible to the member via the promotional object; the web site allowing interactive communication between the member and the web site;
providing, on the web site, at least one benefit supplied by at least one partner of the organization; the benefit being available for the members via the promotional object;
wherein a) the at least one partner and the at least one benefit are dynamically published and controlled; and b) usage of the at least one benefit from the at least one partner by the at least one member operates the on-line loyalty and benefits program to render the at least one member loyal to the at least one partner and/or at least one partner loyal to the organization.

25. A method for implementing an on-line loyalty and benefits program as defined in claim 24, comprising using a dynamically publishing system to dynamically control the web site.

26. A method for implementing an on-line loyalty and benefits program as defined in claim 25, comprising providing the dynamically publishing system with an administration, communication and data center.

27. A method for implementing an on-line loyalty and benefits program as defined in claim 26, wherein the web site is managed by the organization through the administration, communication and data center.

28. A method for implementing an on-line loyalty and benefits program as defined in claim 27, wherein the web site is further managed by a central organization through the administration, communication and data center.

29. A method for implementing an on-line loyalty and benefits program as defined in claim 26, wherein the web site can be changed and customized by the at least one member through the administration, communication and data center.

30. A method for implementing an on-line loyalty and benefits program as defined in claim 26, wherein the web site can be changed and customized by the at least one partner through the administration, communication and data center.

31. A method for implementing an on-line loyalty and benefits program as defined in claim 27, wherein the management of the web site comprises changing at least one of looks, feel and content of the web site.

32. A method for implementing an on-line loyalty and benefits program as defined in claim 26, wherein e-mails and e-newsletters are sent to the at least one member by the organization through the administration, communication and data center.

33. A method for implementing an on-line loyalty and benefits program as defined in claim 32, further comprising generating statistics, sales results, importing or exporting data, and producing reports through the administration, communication and data center.

34. A method for implementing an on-line loyalty and benefits program as defined in claim 27, comprising gathering data about members through the benefits web site and the administration, communication and data center.

35. A method for implementing an on-line loyalty and benefits program as defined in claim 27, comprising tracking online visitors by means of the benefits web site and the administration, communication and data center.

36. A method for implementing an on-line loyalty and benefits program as defined in claim 25, comprising providing the web site through a hosting server.

37. A method for implementing an on-line loyalty and benefits program in claim 36, comprising managing the web site through a group of people including an administrator of the organization and an administrator of the hosting server.

38. A method for implementing an on-line loyalty and benefits program as defined in claim 36, further comprising providing a password-protected user interface that is accessible only by an authorized person.

39. A method for implementing an on-line loyalty and benefits program in claim 38, wherein the authorized person is selected from a group consisting of a member, an administrator from the organization, a partner of the organization and an administrator from the hosting server.

40. A method for implementing an on-line loyalty and benefits program as defined in claim 25, comprising providing the promotional object with an identification code.

41. A method for implementing an on-line loyalty and benefits program as defined in claim 40, comprising providing the promotional object with a logo of the organization.

42. A method for implementing an on-line loyalty and benefits program as defined in claim 40, comprising providing the promotional object with the URL of the web site.

43. A method for implementing an on-line loyalty and benefits program as defined in claim 40, comprising providing the promotional object with an expiration date.

44. A method for implementing an on-line loyalty and benefits program as defined in claim 40, comprising activating the promotional object online via the identification code in order to register to the web site.

45. A method for implementing an on-line loyalty and benefits program as defined in claim 40, comprising listing on the web site all the partners and the benefits of the listed partners.

46. A method for implementing an on-line loyalty and benefits program as defined in claim 25, comprising providing the web site with options for multilinguism.

47. A system for managing a computer network-based loyalty and benefits program for a organization, comprising:
a server adapted to store a program code;
a network in communication with the server, the program code being structured to program the server to perform a method of managing a computer network-based loyalty and benefits program for a organization, the method comprising:
generating a network-based access benefits web site for the organization; and
listing information concerning at least one partner of the organization on the network-based access benefits web site, the partner information including at least one benefit;
a promotional object supplied to at least one member, the promotional object allowing the at least one member to access the network-based access benefits web site and to use the at least one benefit from the at least one partner;
wherein a) information about the network-based access benefits web site is dynamically published and controlled; and b) usage of the at least one benefit from the at least one partner by the at least one member operates the computer network based loyalty and benefits program to render the at least one member loyal to the at least one partner and/or at least one partner loyal to the organization.

48. A system for managing a computer network-based loyalty and benefits program as defined in claim 47, further comprising a dynamically publishing system to dynamically control the benefits web site.

49. A system for managing a computer network-based loyalty and benefits program as defined in claim 48, wherein the dynamically publishing system comprises an administration, communication and data center.

50. A system for managing a computer network-based loyalty and benefits program as defined in claim 47, further comprising a password-protected user interface that is accessible only by an authorized person.

51. A system for managing a computer network-based loyalty and benefits program as defined in claim 47, wherein the promotional object comprises at least one of an identification code, a logo of the organization, the URL of the web site and an expiration date.
